(19) United States
(12) Patent Application Publication
(10) Pub. No.: US 2009/0317707 A1
(43) Pub. Date: Dec. 24, 2009

(54) LITHIUM SECONDARY BATTERY

(76) Inventor: Seungyeob Cha, Yongin-si (KR)

Correspondence Address: CHRISTIE, PARKER & HALE, LLP, PO BOX 7068, PASADENA, CA, 91109-7068, US

(21) Appl. No.: 12/341,936

(22) Filed: Dec. 22, 2008

Related U.S. Application Data
(60) Provisional application No. 61/074,562, filed on Jun. 20, 2008.

(51) Int. Cl. H01M 2/02

(52) U.S. Cl. 429/163

(57) ABSTRACT

Provided is a lithium secondary battery which is capable of preventing high-temperature short circuit by incorporation of a clad negative electrode tab having a nickel/copper bilayer structure.

For this purpose, the present invention provides a lithium secondary battery comprising an electrode assembly including a positive electrode plate, a separator, a negative electrode plate, a positive electrode tab drawn from the positive electrode plate and a clad negative electrode tab drawn from the negative electrode plate and formed of a Ni/Cu bilayer; a can having an open upper part to house the electrode assembly; and a cap assembly for sealing the open upper part of the can, wherein the positive electrode plate, the separator and the negative electrode plate are sequentially wound into a jelly roll configuration.

### BACKGROUND OF THE INVENTION

1. Field of the Invention

The present invention relates to a lithium secondary battery. More specifically, the present invention relates to a lithium secondary battery which is capable of preventing a high-temperature short circuit by using a clad negative electrode tab having a nickel/copper bilayer structure.

2. Description of the Related Art

Generally, a secondary battery is fabricated by housing an electrode assembly and an electrolyte in a can and hermetically sealing an open upper part of the can with a cap assembly.

In order to increase electrical capacity of the cap assembly, the electrode assembly may be prepared to have a jelly roll structure by stacking a positive electrode plate, a negative electrode plate and a separator disposed therebetween to insulate the electrode plates and winding the resulting stacked structure into a jelly roll shape. Even though there may be some differences depending upon kinds of secondary batteries, the positive and negative electrode plates are formed conventionally by applying an electrode active material to a metal substrate, followed by drying, roll pressing and cutting. In the case of a lithium secondary battery, the positive electrode plate employs a lithium transition metal oxide as an electrode active material, and aluminum (Al) as a current collector. On the other hand, the negative electrode plate employs a carbon or carbon composite as an electrode active material, and copper (Cu) as a current collector. The separator serves to electrically isolate the positive electrode plate from the negative electrode plate so as to avoid the occurrence of a short circuit due to direct contact between two electrode plates. The separator is formed of a microporous film of a polyolefin resin, such as polyethylene, polypropylene, or the like.

For electrical connection of the electrode assembly to the cap assembly, a positive electrode tab and a negative electrode tab is formed to protrude from an upper part of the electrode assembly. The positive and negative electrode tabs may be formed of aluminum (Al) or nickel (Ni). Conventionally, the positive electrode tab may be formed of aluminum (Al) or an aluminum alloy, whereas the negative electrode tab may be formed of nickel (Ni) or a nickel alloy.

However, the negative electrode tab made of nickel or nickel alloy suffers from problems associated with production of a large amount of heat upon charging/discharging of the secondary battery, arising from high resistance of Ni per se. Further, since the welding portions between the negative electrode plate and the negative electrode tab and between the cap assembly and the negative electrode tab are joining regions of heterogeneous metal components, internal resistance (IR) increases to result in localization of heat generation. Local concentration of heat may, in tun, cause a high-temperature short circuit, thus causing the danger of explosion of the secondary battery.

### SUMMARY OF THE INVENTION

Therefore, the present invention has been made in view of the above problems, and it is an object of the present invention to provide a lithium secondary battery which is capable of preventing a high-temperature short circuit by provision of a clad negative electrode tab having a nickel/copper bilayer structure.

It is another object of the present invention to provide a lithium secondary battery with reduced internal resistance and heat generation.

### BRIEF DESCRIPTION OF THE DRAWINGS

FIG. 1 is an exploded perspective view of a lithium secondary battery in accordance with an embodiment of the present invention;

FIG. 2a is a perspective view of an electrode assembly in accordance with an embodiment of the present invention, before winding of electrode components;

FIG. 2b is a perspective view of an electrode assembly in accordance with an embodiment of the present invention, after winding of electrode components;

FIG. 2c is a plan view of an electrode assembly in accordance with an embodiment of the present invention;

FIG. 3a is a sectional view of a negative electrode tab in accordance with an embodiment of the present invention;

FIG. 3b is a side plan view of a negative electrode tab in accordance with an embodiment of the present invention;

FIG. 4a is a graph showing the relationship between kinds of negative electrode tabs and a heat generation temperature; and

FIG. 4b is a graph showing the relationship between kinds of negative electrode tabs and a depth of thermal oxidation.

### DETAILED DESCRIPTION OF THE PREFERRED EMBODIMENTS

Now, exemplary embodiments of the present invention will be described in more detail with reference to the accompanying drawings.

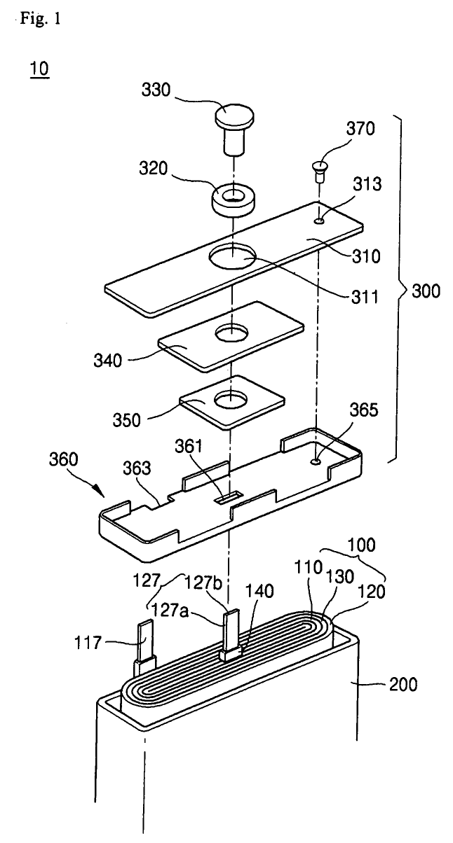

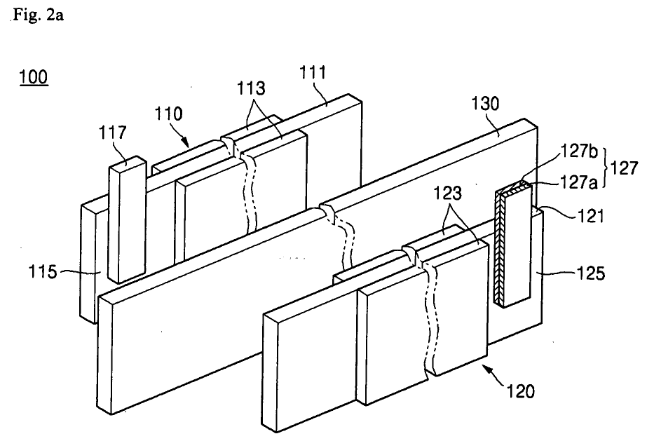

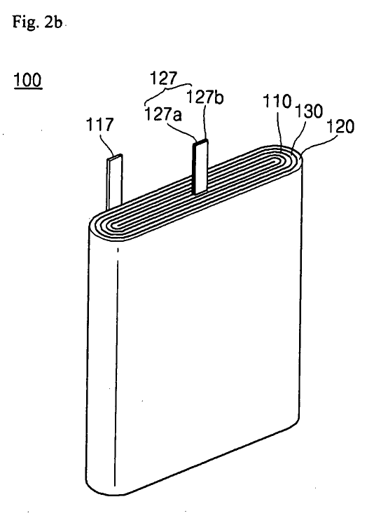

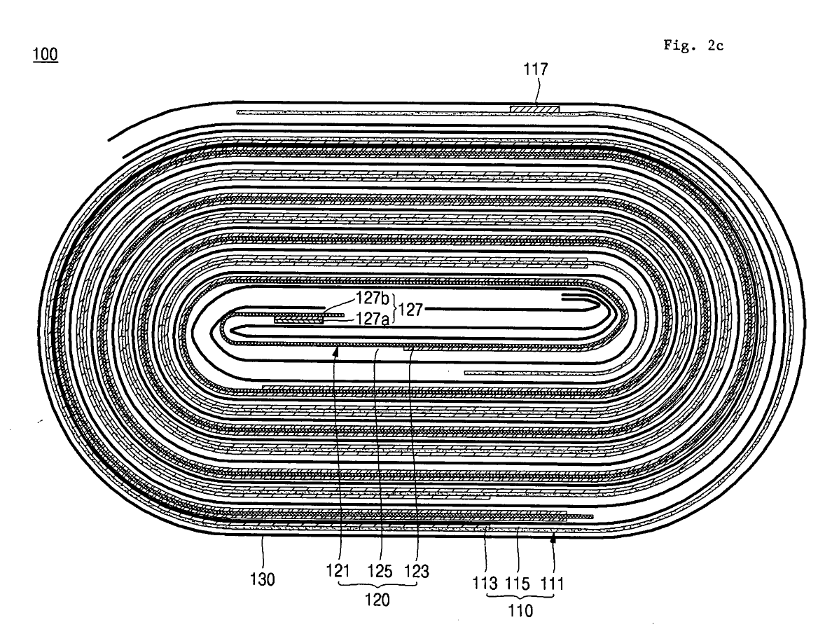

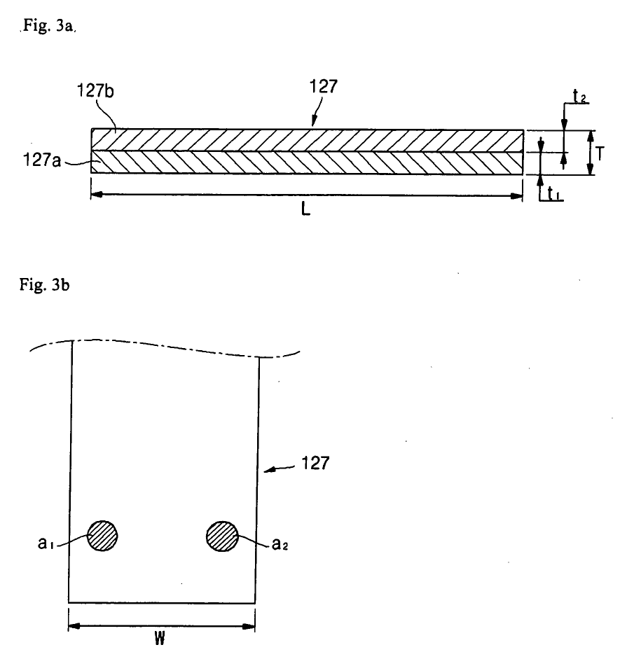

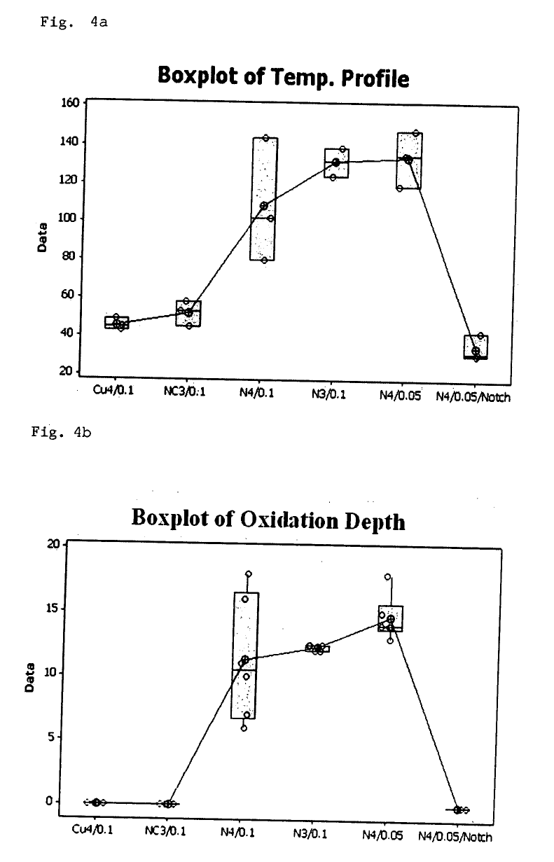

FIG. 1 is an exploded perspective view of a lithium secondary battery in accordance with an embodiment of the present invention. FIG. 2a is a perspective view of an electrode assembly in accordance with an embodiment of the present invention, before winding of electrode components, FIG. 2b is a perspective view of an electrode assembly in accordance with an embodiment of the present invention, after winding of electrode components, and FIG. 2c is a plan view of an electrode assembly in accordance with an embodiment of the present invention. FIG. 3a is a side view of a negative electrode tab in accordance with an embodiment of the present invention, and FIG. 3b is a side plan view of a negative electrode tab in accordance with an embodiment of the present invention. Finally, FIG. 4a is a graph showing the relationship between kinds of negative electrode tabs and a heat generation temperature, and FIG. 4b is a graph showing the relationship between kinds of negative electrode tabs and a depth of thermal oxidation.

Referring to FIGS. 1 to 3b, a lithium secondary battery 10 in accordance with an embodiment of the present invention includes an electrode assembly 100, a can 200 and a cap assembly 300. The electrode assembly 100 further includes a clad negative electrode tab 127 having a bilayer structure of nickel (Ni) 127a and copper (Cu) 127b. The clad negative electrode tab 127 is a negative electrode tab with improved electrical properties, as compared to a conventional art negative electrode tab. That is, an embodiment of the present invention provides a lithium secondary battery 10 having improved short-circuit characteristics at high temperatures, by using the clad negative electrode tab 127 as a negative electrode tab of the lithium secondary battery 10.

The electrode assembly 100 includes a positive electrode plate 110, a negative electrode plate 120 and a separator 130. In order to increase electrical capacity, the electrode assembly 100 is conventionally fabricated into a jelly roll structure by stacking the positive electrode plate 110, the negative electrode plate 120 and the separator 130 disposed therebetween to provide electrical isolation between the electrode plates 110 and 120, and winding the resulting stacked structure into a jelly roll.

The positive electrode plate 110 includes a positive electrode current collector 111, a positive electrode active material layer 113, a positive electrode non-coating portion 115 and a positive electrode tab 117. The positive electrode current collector 111 is formed of thin aluminum (Al) foil. The positive electrode active material layer 113 is coated on both sides of the positive electrode current collector 111. The positive electrode active material layer 113 may be made of a lithium manganese oxide having high stability. The positive electrode non-coating portion 115 is defined as a region of the positive electrode current collector 111 which was not coated with the positive electrode active material layer 113. The positive electrode non-coating portion 115 may be formed on both ends of the positive electrode current collector 111. The positive electrode tab 117 is formed to be fixed to the positive electrode non-coating portion 115. For electrical connection with the cap assembly 300, one end of the positive electrode tab 117 is formed to protrude upward above the positive electrode current collector 111, and is formed to protrude upward from an outer periphery of the electrode jelly roll structure. The positive electrode tab 117 may be made of aluminum (Al) or nickel (Ni). The portion with a protrusion of the positive electrode tab 117 is wound with an insulating tape 140 for prevention of an electrode-to-electrode short circuit.

The negative electrode plate 120 includes a negative electrode current collector 121, a negative electrode active material layer 123, a negative electrode non-coating portion 125 and a clad negative electrode tab 127. The negative electrode current collector 121 is formed of thin copper (Cu) foil. The negative electrode active material layer 123 is coated on both sides of the negative electrode current collector 121. The negative electrode active material layer 123 may be made of a carbon material. The negative electrode non-coating portion 125 is defined as a region of the negative electrode current collector 121 which was not coated with the negative electrode active material layer 123. The negative electrode non-coating portion 125 may be formed on both ends of the negative electrode current collector 121. The clad negative electrode tab 127 is formed to be fixed to the negative electrode non-coating portion 125. For electrical connection with the cap assembly 300, one end of the clad negative electrode tab 127 is formed to protrude upward above the negative electrode current collector 121. The portion with a protrusion of the clad negative electrode tab 127 is wound with an insulating tape 140 for prevention of a short circuit between the electrodes. Further, the clad negative electrode tab 127 is formed to protrude upward from an inner periphery of the electrode jelly roll structure.

Hereinafter, a clad negative electrode tab in accordance with an embodiment of the present invention will be described in more detail.

The clad negative electrode tab 127 is made of a bilayer structure of nickel (Ni) 127a and copper (Cu) 127b. Further, the clad negative electrode tab 127 is formed by pressure welding of Ni 127a and Cu 127b. Ni 127a is a metal material having a resistance/unit sectional area which is about 4 times higher than that of Cu 127b. Therefore, when a clad is formed of Ni 127a and Cu 127b, the presence of Cu 127b results in lowering of resistance of the electrode tab, so resistance of the electrode tab can be reduced to a half of a conventional negative electrode tab formed of Ni or Ni-containing alloy. According to an embodiment of the present invention, the clad negative electrode tab 127 may exhibit a resistance value of 2.0 to 5.0 mΩ which corresponds to a half reduction of the tab resistance, as compared to when a negative electrode tab of the Ni 127a monolayer having the same sectional area exhibits a resistance value of about 7.5 mΩ. That is, the clad negative electrode tab 127 provides reduced heat generation due to having decreased resistance, as compared to a conventional art negative electrode tab. As a result, it is possible to improve high-temperature short circuit characteristics of the lithium secondary battery 10. The reason why the negative electrode tab is not formed only of low-resistance Cu 127b is as follows. When the electrode assembly 100 or the cap assembly 300 is welded with the negative electrode tab, the Cu component is melted by heat. If a large amount of Cu 127b is present, spattering of Cu particles may occur upon melting of Cu, which consequently results in a micro short circuit of the lithium secondary battery 10 by fine particles.

The clad negative electrode tab 127 is preferably formed to have a length (L) of 10 to 50 mm. If a length (L) of the clad negative electrode tab 127 is shorter than 10 mm, it may be difficult to secure a welding space when the negative electrode tab 127 is welded with a negative electrode non-coating portion 125 of the negative electrode plate 120 or is welded with a terminal plate 350 of the cap assembly 300. On the other hand, if a length (L) of the clad negative electrode tab 127 is longer than 50 mm, it may be likely to result in a short circuit due to potential contact of the electrode tab 127 with the cap plate 310 or the positive electrode tab 117. Further, since the resistance of an ohmic conductor is proportional to its length, it is meaningless that the clad negative electrode tab 127 has a length (L) larger than a desired size.

The clad negative electrode tab 127 is preferably formed to have a thickness (T) of 0.05 to 0.15 mm. If a thickness (T) of the clad negative electrode tab 127 is thinner than 0.05 mm, the tab 127 may be broken when it is welded or bent several times in the process of housing the electrode assembly into the can. On the other hand, if a thickness (T) of the clad negative electrode tab 127 is thicker than 0.15 mm, it may result in a prolonged process time when the clad negative electrode tab 127 is welded with the negative electrode non-coating portion 125 of the negative electrode plate 120 or with the terminal plate 350 of the cap assembly 300. As described above, the clad negative electrode tab 127 is inevitably bent several times in the process of housing the electrode assembly into the can. Therefore, when the clad negative electrode tab 127 is formed to have a thickness (T) of more than 0.15 mm, such a large thickness (T) results in decreased flexibility, which may, in turn, lead to difficulty of installation.

Further, the clad negative electrode tab 127 is preferably formed to have a width (W) of 2.0 to 5.0 mm. Upon welding with the negative electrode non-coating portion 125 of the negative electrode plate 120 or with the terminal plate 350 of the cap assembly 300, the clad negative electrode tab 127 is welded through two or more weld points. Therefore, if a width (W) of the clad negative electrode tab 127 is narrower than 2.0 mm, it may be difficult to secure a welding space. On the other hand, if a width (W) of the clad negative electrode tab 127 is wider than 5.0 mm, a welding process requires larger numbers of weld points for firm welding, which results in increased numbers of additional processes, thus lowering the productivity.

Meanwhile, it is preferred that each layer of Ni 127a and Cu 127b is formed to have a 5 to 95% thickness of a counterpart layer of the clad negative electrode tab 127. That is, for example, when the Ni layer 127a is formed to have a 5% thickness proportion based on the total thickness of the clad negative electrode tab 127, the Cu layer 127b may have a 95% thickness proportion. On the other hand, when the Ni layer 127a is formed to have a 95% thickness proportion of the clad negative electrode tab 127, the Cu layer 127b may be formed to have a 5% thickness proportion of the clad negative electrode tab 127. If the Ni layer 127a has a thickness proportion of less than 5%, an excessive amount of Cu 127b may cause a problem associated with spattering of Cu 127b during a welding process. On the other hand, if Cu 127b is formed to have a thickness proportion of less than 5%, it is difficult to achieve desired reduction of resistance. If Ni 127a accounts for a thickness proportion of more than 95%, it is difficult to achieve desired reduction of resistance. On the other hand, if Cu 127b is formed to have a thickness proportion of more than 95%, spattering of Cu 127b may occur during a welding process. Therefore, a proportion of the as-formed thickness (t₁, t₂) of Ni 127a and Cu 127b should be set taking into consideration the resistance and spattering of the clad negative electrode tab 127. It is preferred that Ni 127a and Cu 127b have the same layer thickness.

One end of the clad negative electrode tab 127 is welded with the negative electrode plate 120, whereas the other end of the clad negative electrode tab 127 is welded with the cap assembly 300. More specifically, the negative electrode non-coating portion 125 of the negative electrode plate 120 is welded in contact with one end of the Cu layer 127b of the clad negative electrode tab 127, and a welding rod is in contact with the Ni layer 127a. Further, the terminal plate 350 of the cap assembly 300 is welded in contact with the other end of the Cu layer 127b of the clad negative electrode tab 127, and a welding rod is in contact with the Ni layer 127a. As described above, welding of the clad negative electrode tab 127 with the negative electrode plate 120 or the cap assembly 300 may be carried out using any conventional method selected from ultrasonic welding, laser welding, and resistance welding.

In order to improve the bonding strength upon welding with the negative electrode plate 120 or the cap assembly 300, the clad negative electrode tab 127 may be welded in at least two weld points (a₁, a₂). When the spacing between two weld points a₁ and a₂ is narrow, there is no significant difference when compared with single-point welding. Therefore, it is preferred that the weld points (a₁, a₂) are formed spaced apart on the clad negative electrode tab 127. Of course, the weld points (a₁, a₂) may also be additionally formed to further improve the bonding strength between the clad negative electrode tab 127 and the negative electrode plate 120 or the cap assembly 300.

The separator 130 prevents a short circuit between the positive electrode plate 10 and the negative electrode plate 120, and serves as a migration path of lithium ions. The separator 130 is formed of polyethylene or polypropylene, even though there is no particular limit to the material for the separator 130.

In the polygonal secondary battery, the can 200 has a generally rectangular parallelepiped shape made of metal, which has an open-end part and is formed by a processing method such as deep drawing. The can 200 may be formed of an aluminum alloy or aluminum that is a light-weight conductive metal. Therefore, the can 200 can also serve as a terminal. The can 200 serves as a container of the electrode assembly 100 and the electrolyte, and has an open upper part to allow insertion of the electrode assembly 100 and is hermetically sealed by the cap assembly 300.

The cap assembly 300 includes a cap plate 310, a gasket 320, an electrode terminal 330, an insulation plate 340, a terminal plate 350, an insulating case 360 and a plug 370.

The cap plate 310 includes a terminal through-hole 311 and an electrolyte injection hole 313. The terminal through-hole 311 provides a path through which the electrode terminal 330 is inserted. For insulation of the metallic cap plate 310 from the electrode terminal 330, the electrode terminal 330 is inserted into the terminal through-hole 311 after the gasket 320 made of an insulating material is positioned around an exterior surface of the electrode terminal 330. One side of the cap plate 310 is provided with an electrolyte injection hole 313 for injection of an electrolyte into the can 200. After injection of the electrolyte is complete, the electrolyte injection hole 313 is sealed with a plug 370 to prevent leakage of the electrolyte.

The insulating plate 340 is installed below the cap plate 310. Below the insulating plate 340 is provided a terminal plate 350. Therefore, the insulating plate 340 provides insulation between the cap plate 310 and the terminal plate 350. Meanwhile, the terminal plate 350 is formed to be coupled with a lower end of the electrode terminal 330. Therefore, the negative electrode plate 120 of the electrode assembly 100 is electrically connected to the electrode terminal 330 through the clad negative electrode tab 127 and the terminal plate 350. The positive electrode plate 110 of the electrode assembly 100 is electrically connected to the cap plate 310 or the can 200 through the positive electrode tab 117.

The insulating case 360 is installed below the terminal plate 350. The insulating case 360 includes a negative electrode tab pass-through portion 361, a positive electrode tab pass-through portion 363 and an electrolyte inlet 365.

The plug 370 is used to hermetically seal the electrolyte injection hole 313 after injection of the electrolyte into the hole 313 formed on the cap plate 310. As an alternative to the plug 370, a ball may be press-fitted to seal the electrolyte injection hole 313.

As described above, the lithium secondary battery 10 in accordance with an embodiment of the present invention is provided with the clad negative electrode tab 127 having a bilayer structure of Ni 127a and Cu 127b. The clad negative electrode tab 127 exhibits lower resistance as compared to that of a conventional art. Therefore, according to the embodiment of the present invention, it is possible to improve high-temperature short circuit characteristics of the lithium secondary battery 10. That is, according to the embodiment of the present invention, resistance of the lithium secondary battery 10 can be decreased to thereby result in reduction of heat generation in the lithium secondary battery 10, ultimately by which the lithium secondary battery 10 can be protected against the risk of explosion and malfunction.

Table 1 shows the resistance, resistivity, heat generation temperature and thermal oxidation depth measured for individual metals used as an electrode tab material. FIGS. 4a and 4b graphically show the measured values of Table 1. Hereinafter, an explanation will be given with reference to Table 1 and FIGS. 4a and 4b.

TABLE 1

| | | | | | | Oxidation |
|---|---|---|---|---|---|---|
| | | | Tab IR | Resistivity | Temp. | depth |
| | | Spec. | [mmΩ] | [Ω · m] | [° C.] | [mm] |
| Embod- | Ni/Cu | L: 3 mm | 3.3 | 2.52E−8 | 52.0 | 0.0 |
| iment 1 | clad | T: 0.1t | | | | |
| Comp. | Cu tab | L: 4 mm | 1.6 | 1.72E−8 | 45.7 | 0.0 |
| Ex. 1 | | T: 0.1t | | | | |
| Comp. | Ni tab | L: 4 mm | 7.5 | 9.13E−8 | 108.7 | 11.3 |
| Ex. 2 | | T: 0.1t | | | | |
| Comp. | Ni tab | L: 3 mm | 11.5 | 8.86E−8 | 124.3 | 12.0 |
| Ex. 3 | | T: 0.1t | | | | |
| Comp. | Ni tab | L: 4 mm | 14.3 | 11.1E−8 | 134.0 | 14.7 |
| Ex. 4 | | T: 0.05t | | | | |
| Comp. | Ni tab | L: 4 mm | 16.8 | 13.0E−8 | 35.3 | 0.0 |
| Ex. 5 | | T: 0.05t | | | | |
| | | (notch) | | | | |

In Table 1 above, Embodiment 1 shows the internal resistance, resistivity, heat generation temperature and oxidation depth measured for the clad negative electrode tab 127 having a bilayer structure of Ni 127a and Cu 127b. Comparative Example 1 shows the internal resistance, resistivity, heat generation temperature and oxidation depth measured for the Cu electrode tab, whereas Comparative Examples 2 to 5 show the internal resistance, heat generation temperature and oxidation depth of the Ni electrode tab with respect to length (L) and thickness (T) thereof, in conjunction with resistivity of tab materials.

The clad negative electrode tab 127 of Embodiment 1 exhibited lower resistance and resistivity, as compared to the Ni electrode tabs of Comparative Examples 2 to 4. Further, the clad negative electrode tab 127 of Embodiment 1 exhibited a relatively low heat generation temperature, as compared to the Ni electrode tabs of Comparative Examples 2 to 4. Further, it can be seen that the clad negative electrode tab 127 of Embodiment 1 exhibits substantially no formation of a thermal oxide film. That is, as shown in Table 1, it can be seen that the heat generation temperature increases as the resistance is higher, whereby an insulating thermal oxide film is formed on the electrode plate surface.

The Cu electrode tab of Comparative Example 1 exhibited low resistance and resistivity values, whereby the heat generation temperature is low and a thermal oxide is not substantially formed. However, as discussed hereinbefore, the electrode tab made only of Cu was not employed due to the potential problem of copper scattering.

On the other hand, Comparative Example 5 shows the internal resistance, heat generation temperature and oxide depth measured for the Ni electrode tab with formation of a notch. The Ni electrode tab of Comparative Example 5 exhibited a relatively low heat generation temperature and no formation of a thermal oxide, but had a disadvantage of high resistance.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A secondary battery comprising:
a can;
an electrode assembly within the can comprising a first electrode plate, a second electrode plate and a separator between the first electrode plate and the second electrode plate, the first electrode plate having a coated portion coated with an active material and an uncoated portion absent the active material;
a cap assembly for sealing the can; and
a first electrode tab electrically connecting the uncoated portion of the first electrode plate to the cap assembly, the first electrode tab comprising a bilayer structure comprising a copper layer and a nickel layer.

2. The secondary battery of claim 1, wherein the copper layer is pressure-welded to the nickel layer.

3. The secondary battery of claim 1, wherein the first electrode tab is a clad electrode tab.

4. The secondary battery of claim 1, wherein the first electrode tab exhibits a resistance from about 2.0 to 5.0 mΩ.

5. The secondary battery of claim 1, wherein a thickness of the first electrode tab comprises between about 5% to 95% copper and between about 5% and 95% nickel.

6. The secondary battery of claim 1, wherein a thickness of the first electrode tab comprises about 50% copper and about 50% nickel.

7. The secondary battery of claim 1, wherein a thickness of the first electrode tab is from about 0.05 mm to 0.15 mm.

8. The secondary battery of claim 1, wherein the first electrode tab extends substantially parallel to the first electrode plate of the electrode assembly.

9. The secondary battery of claim 1, wherein a thickness of the copper layer is substantially the same as a thickness of the nickel layer.

10. The secondary battery of claim 1, wherein the first electrode tab is welded to the uncoated portion of the first electrode plate so that the copper layer of the first electrode tab contacts the uncoated portion of the first electrode plate.

11. An electrode tab for a secondary battery comprising a can, an electrode assembly within the can including a first electrode plate having an uncoated portion absent an active material, a second electrode plate and a separator between the first electrode plate and the second electrode plate, and a cap assembly adapted to seal the can, the electrode tab adapted to be attached to the uncoated portion of the first electrode plate and comprising a clad bilayer structure comprising:
a copper layer; and
a nickel layer.

12. The electrode tab of claim 11, wherein the copper layer is pressure-welded to the nickel layer.

13. The electrode tab of claim 11, wherein the electrode tab exhibits a resistance from about 2.0 to 5.0 mΩ.

14. The electrode tab of claim 11, wherein a thickness of the first electrode tab comprises between about 5% to 95% copper and between about 5% and 95% nickel.

15. The electrode tab of claim 11, wherein a thickness of the electrode tab comprises about 50% copper and about 50% nickel.

16. The electrode tab of claim 11, wherein a thickness of the electrode tab is from about 0.05 mm to 0.15 mm.

17. The electrode tab of claim 11, wherein the electrode tab extends substantially parallel to the first electrode plate of the electrode assembly.

18. The secondary battery of claim 11, wherein a thickness of the copper layer is substantially the same as a thickness of the nickel layer.
